(19) United States
(12) Patent Application Publication
(10) Pub. No.: US 2007/0127336 A1
(43) Pub. Date: Jun. 7, 2007

(54) Optical disk apparatus and method of setting recording power

(76) Inventors: Mitsunori Kobayashi, Chigasaki (JP); Koichi Watanabe, Hachiouji (JP); Kazutoshi Shigeta, Tokyo (JP)

Correspondence Address: MCDERMOTT WILL & EMERY LLP, 600 13TH STREET, N.W., WASHINGTON, DC, 20005-3096, US

(21) Appl. No.: 11/429,442

(22) Filed: May 8, 2006

(30) Foreign Application Priority Data
Dec. 1, 2005 (JP) 2005-347484

(51) Int. Cl. G11B 7/12

(52) U.S. Cl. 369/47.53

(57) ABSTRACT

According to the present invention, an optimum value of a laser power for recording data on a high-density optical disk can be set with high accuracy. A test signal whose erase power Pe is fixed and recording power Pw is varied is recorded on the optical disk. The recorded signal is reproduced and a β value representing asymmetry of the reproduced signal is obtained for each recording power. An optimum recording power Pwo is set from a recording power with which the obtained β value becomes a target β value. Hereby, the fixed erase power Pe is determined from measurement results of a value of a modulation factor M of another test signal recorded. Alternatively, the fixed erase power Pe follows strategy information defined in advance for the optical disk. Or Pe≈0 is used regardless of the optical disk.

### CLAIM OF PRIORITY

The present application claims priority from Japanese application serial no. JP 2005-347484, filed on Dec. 1, 2005, the content of which is hereby incorporated by reference into this application.

### BACKGROUND OF THE INVENTION

1. Field of the Invention

The present invention relates to an optical disk apparatus which optimally adjusts a recording power when data is recorded on an optical disk and a method of setting the recording power.

2. Description of the Related Art

Heretofore, when data is recorded on an optical disk, test recording is carried out to determine the optimal recording power of a laser light, and data is recorded based on the power as a condition so as to obtain sufficient recording quality for each optical disk. This step is referred hereinafter to as OPC (Optimum Power Control). In such a step, various kinds of methods are implemented and suggested as a parameter for evaluating the recording quality. A method by which the asymmetry (β value) of recorded signals is used as an evaluation index (β method) is used for CDs and DVDs. In addition, for high-density and large-capacity BDs (Blu-ray), the κ method in which a modulation factor is used as an evaluation index and a change in the same is approximated by a straight line to determine an optimum value is recommended (κ method for BD-RE, κ method or β method for BD-R). It should be noted that the parameters for setting recording conditions in each method are stored as control data for each optical disk.

In addition, improvements of these methods which set optimum conditions highly accurately are suggested. JP-A No. 116027/2005 discloses, as an improvement of the β method, a method of setting a recording power based on a value relating to reflectance obtained from an optical disk and a β value. Moreover, JP-A No. 149538/2005 discloses, as an improvement of the κ method, a method in which a modulation factor is measured twice and an optimum value is determined from the measurement results of a range centered around a target power level.

### SUMMARY OF THE INVENTION

In high-density and large-capacity disks such as BD, more precise setting of an optimum recording power is required. The β method mentioned above is a method which can easily conduct evaluation, but it has low measurement sensitivity in the vicinity of the optimum power (a change in the β value relative to the recording power value is small), making highly accurate measurement difficult. Also in the above κ method, the power is low in the vicinity of the value approximated by a straight line and therefore the measurement accuracy is low, causing large variation. In addition, in a two-layer disk, a layer in which test recording is conducted may be interfered by already recorded signals in the other layer at the same position, which may affect the measurement value of the modulation factor.

In the method described in JP-A No. 116027/2005, a new technique of measuring values relating to reflectance is necessary. Moreover, in the method described in JP-A No. 149538/2005, measurement of the β value needs to be carried out twice.

An object of the present invention is to provide a technique for setting an optimum recording power highly accurately by a method different from those in the publications mentioned above.

An optical disk apparatus according to the present invention includes a signal forming circuit that produces a first test signal, an optical pickup that irradiates an optical disk with a laser light based on the first test signal provided from the signal forming circuit to record the first test signal and reproduces the first test signal from the optical disk, a detection circuit that obtains a β value representing asymmetry from the first test signal reproduced by the optical pickup, and a control circuit that sets an optimum recording power Pwo from such a recording power with which the β value obtained by the detection circuit becomes a target β value. The signal forming circuit produces a test signal whose erase power Pe is fixed and recording power Pw is varied as the first test signal.

Herein, the signal forming circuit produces a second test signal to determine an erase power Pe used for the first test signal and records it on the optical disk. The detection circuit obtains a value of a modulation factor M representing an amplitude value from a second test signal reproduced from the optical disk. The signal forming circuit determines the erase power Pe used for the first test signal based on a result of the value of the modulation factor M obtained by the detection circuit.

Alternatively, the signal forming circuit determines the erase power Pe used for the first test signal according to recording conditions recorded in advance on the optical disk or recording conditions defined by the apparatus for the optical disk.

Alternatively, the signal forming circuit uses an approximately zero value (Pe≈0) as the erase power Pe used for the first test signal.

A method of setting a recording power according to the present invention records on the optical disk a test signal whose erase power Pe is fixed and recording power Pw is varied, reproduces the recorded signal and obtains the β value representing the asymmetry of a reproduced signal for each recording power, and sets an optimum recording power Pwo from a recording power with which the obtained β value becomes a target β value.

According to the present invention, the optimum recording power can be highly accurately set, and therefore the recording quality of the data recorded on the optical disk can be improved.

### BRIEF DESCRIPTION OF THE DRAWINGS

Theses and other features, objects and advantages of the present invention will become more apparent from the following description when taken in conjunction with the accompanying drawings.

FIG. 1 is a block diagram showing an example of the optical disk apparatus according to the present invention;

FIG. 2 schematically shows a recorded waveform for test recording;

FIG. 3A to 3C are drawings which compare a conventional method with a method of an embodiment of the present invention with respect to the β value measurement;

FIGS. 4A and 4B are drawings which depict the measurement method of the κ method used in combination in an embodiment of the present invention;

FIG. 5 is a flowchart of a method (1) of setting an optimum recording power;

FIG. 6 is a flowchart of a method (2) of setting an optimum recording power; and

FIG. 7 is a flowchart of a method (3) of setting an optimum recording power.

### DETAILED DESCRIPTION OF THE PREFERRED EMBODIMENT

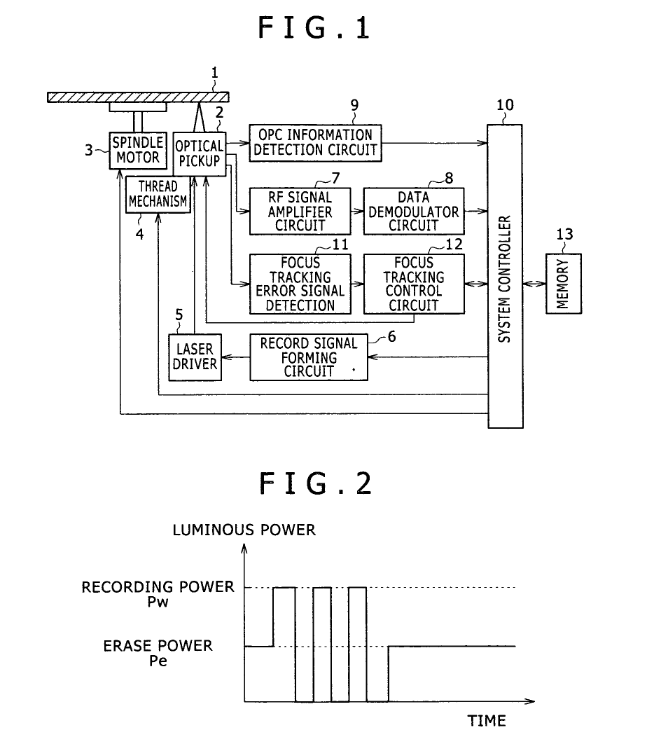

FIG. 1 is a block diagram showing an embodiment of an optical disk apparatus according to the present invention. The apparatus of this embodiment of the present invention rotates a recordable optical disk 1 (for example, BD) by a spindle motor 3, irradiates the recording face of the optical disk 1 with a laser light produced by a semiconductor laser from an optical pickup 2, and records or reproduces data or a test signal. A thread mechanism 4 moves the optical pickup 2 to a desired track position on the optical disk. A recording signal forming circuit 6 produces data or a test signal to be recorded, and a laser driver 5 controls the luminous power of the semiconductor laser based on the data or test signal. As a result, the data or test signal is recorded at the desired track position on the optical disk.

Meanwhile, the optical pickup 2 reproduces data or a test signal from the optical disk 1. The reproduced signal (RF signal) is amplified by an RF signal amplifier circuit 7, and demodulated by a data demodulator circuit to be reproduced data (information). An OPC information detection circuit 9 obtains OPC information (quality such as β value) from a reproduction result of the test signal. In the control region of the optical disk 1, recording conditions (strategy information hereinafter) including recording power setting of this optical disk are recorded in advance as control data, and the control data is read out to be used to determine optimum recording conditions. A focus/tracking error signal detector 11 detects, for example, the level of the reproduced signal (RF signal) and produces a focus error signal and a tracking error signal. A focus/tracking control circuit 12 carries out the focus control and tracking control of the optical pickup 2 based on the error signal. A system controller (control circuit) 10 carries out the control of the whole apparatus including a recording power setting step (OPC), and stores the programs and data for doing the same in a memory 13.

With regard to the setting of an optimum recording power, a test signal which is a recording power or the like changed stepwise is formed in a record signal forming circuit 6 with reference to the strategy information, and the signal is recorded onto the OPC region of the optical disk 1. Subsequently, the test signal is reproduced by the optical pickup 2, and the quality (modulation factor and asymmetry) of the reproduced waveform in the OPC information detection circuit 9 is determined. The system controller (control circuit) 10 determines an optimum value of the recording power based on the measurement results of the quality.

Subsequently, a method of setting the optimum recording power in this embodiment will be described.

FIG. 2 schematically shows a waveform for test recording. The vertical axis represents the luminous power level; the symbol Pw represents the recording power; and Pe represents the erase power. The recording power Pw is varied stepwise within a predetermined range. At that time, the erase power Pe is fixed (Pe is varied so that the ratio Pw/Pe is constant as well as the recording power Pw in some steps).

In this Example, the following indexes are used in the quality evaluation of the reproduced waveform. One of them is the β value representing the asymmetry of the positive and negative amplitude of the reproduced waveform. The other is a modulation factor M which represents the magnitude of the amplitude of the reproduced waveform by its ratio to the maximum (saturation) amplitude. Heretofore, the target value (Target) of the β value or M value is set and the optimum recording power Pwo is determined based on the power Pw with which the target value can be obtained. This Example is an improvement of the method.

In this Example, the β method which evaluates the quality with the β value is employed to determine the optimum recording power. In the κ method which uses the modulation factor M as an index, the modulation factor M is measured relative to the peak level (absolute value) of an RF amplitude. Therefore, contaminating signals from another layer (already recorded) affect the modulation factor as an offset in a two-layer medium, and they are difficult to avoid. In contrast, in the β method, since the β value is determined from the ratio of a difference between the peak level and the DC level (relative value) to the RF amplitude, there is no influence of the offset from another layer. Further this embodiment is characterized in that the erase power Pe of the test signal is fixed to improve its accuracy.

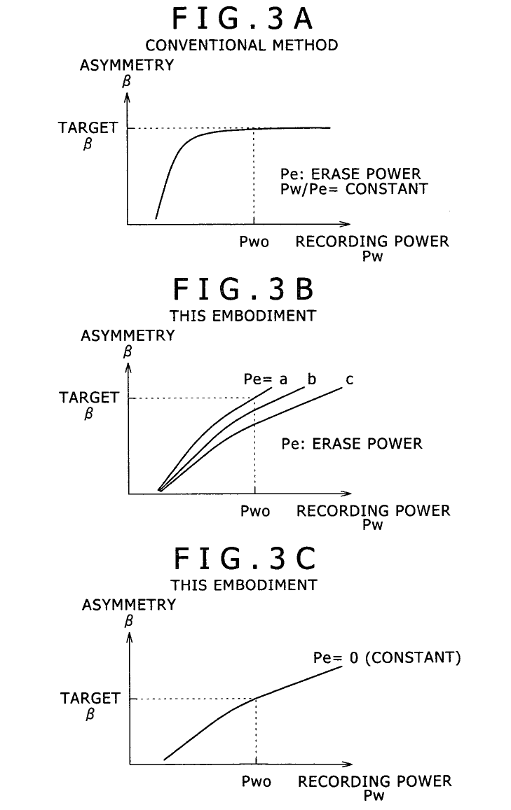

FIG. 3A to 3C are drawings for comparing a conventional method and the method of an Example of the present invention with respect to β value measurement. FIG. 3A represents a conventional method, in which the β value is measured by varying the erase power Pe together with the recording power Pw so that the Pw/Pe ratio becomes constant. By this method, however, the inclination of the curve is steep in a low power region, while the inclination of the curve is gentle in a high power region in which the target value, Target_β can be obtained. When precise adjustment is required as in BD, it needs to be such a curve that has an appropriate inclination, and therefore determining the optimum value Pwo of the recording power highly accurately is difficult.

In contrast, in FIG. 3B, the erase power Pe is fixed and only Pw is varied to measure the β value. By this method, the inclination of the curve in a high power region becomes appropriate (measurement sensitivity is high), whereby the optimum power Pwo can be accurately determined relative to Target_β. However, the β curve is shifted depending on how the value Pe is given (values a, b, c), thereby shifting the value of the determined optimum value Pwo. Accordingly, the value Pe needs to be correctly determined in advance. FIG. 3C shows the case where the value Pe is fixed at 0. Also in this case, the inclination of the β curve becomes appropriate, but correction for setting the value Pe to 0 (for example, correction of Target_β) is required.

It should be noted that when the value of the optimum value Pwo is set, the recording power value with which the target value Target_β can be obtained is not necessarily used directly as the optimum value Pwo, but the recording power value with which the target value Targets_β can be obtained may be multiplied by a predetermined coefficient to determined the value of the optimum value Pwo.

The procedure of a specific method of setting an optimum recording power in which the erase power Pe is fixed will be described below by using a flowchart.

<Setting Method 1>

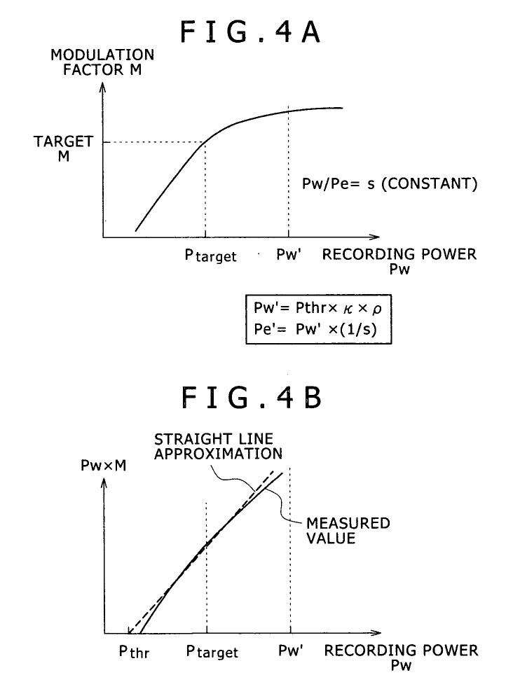

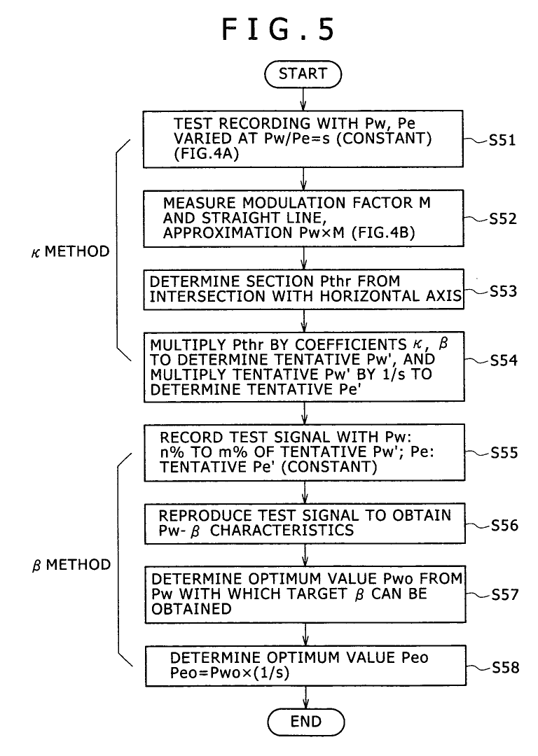

FIG. 5 is a flowchart of a method (1) of setting an optimum recording power when the κ method using the modulation factor M as an index is used in combination to determine Pe which is to be fixed. FIGS. 4A and 4B are graphs for explaining the measurement method of the κ method used in combination.

In steps S51 to S54, tentative Pw (Pw′) and tentative Pe (Pe′) are determined by the κ method. In step S51, when Pw/Pe=s (a known coefficient, constant), test recording is carried out with Pw and Pe varied to determine the modulation factor M (FIG. 4A). The coefficient s at this time is used referring to the strategy information contained in the control data of the optical disk, or the strategy information defined by the manufacturer of the apparatus for its optical disk in the memory 13. In step S52, in the vicinity of Pw (Ptarget) with which the modulation factor M becomes the target value Target_M, the relationship between the product of Pw and M (Pw×M) and Pw is approximated by a straight line (FIG. 4B). In step S53, the value Pw of the intersection with the horizontal axis (Pw×M=0) is regarded as the section Pthr. In step S54, tentative Pw′ is determined by multiplying Pthr by predetermined coefficients κ, ρ (both known), and tentative Pe′ is determined by multiplying Pw′ by 1/s.

Subsequently in steps S55 to S58, the optimum value Pwo and Peo are determined by the β method. In step S55, Pw is varied within a predetermined range of n % to m % centered around tentative Pw′ and Pe is fixed at tentative Pe′ to record a test signal. In step S56, the test signal is reproduced and the OPC information, which is the β value (asymmetry) herein, is obtained. In step S57, the optimum value Pwo is determined from Pw with which the β value becomes Target_β. In step S58, the optimum value Peo is determined by multiplying Pwo by 1/s.

According to this method, since the value Pe′ determined by the κ method is used as the value Pe for measuring β, it has extremely high precision and is capable of setting an accurate recording power. The optimum value Pe varies depending on the type of the disk, the variation of the drive and the temperature condition, but this method always allows stable setting for these variations.

<Setting Method 2>

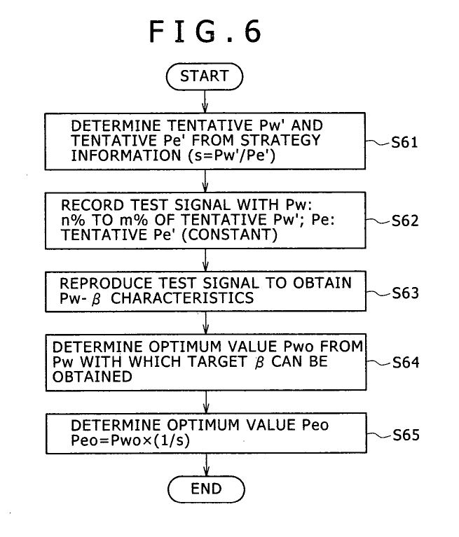

FIG. 6 is a flowchart of a method (2) of setting an optimum recording power when the strategy information and the like of this disk are referred to in order to determine Pe which is to be fixed.

In step S61, the strategy information is read out from the control data of the optical disk or the memory 13 of the apparatus, tentative Pw′ and tentative Pe′ are set from the described value, and their ratio Pw′/Pe′=s. In step S62, Pw is varied within a predetermined range of n % to m % centered around tentative Pw′, and Pe is fixed at tentative Pe′ to record a test signal. In step S63, the test signal is reproduced to obtain the β value. In step S64, the optimum value Pwo is determined from Pw with which the β value becomes Target_β. In step S65, the optimum value Peo is determined by multiplying Pwo by 1/s.

According to this method, the procedure of power setting is shortened. That is, the steps of the κ method (S51 to S54) carried out in the above <setting method 1>can be dispensed with, allowing shortened setting time.

<Setting Method 3>

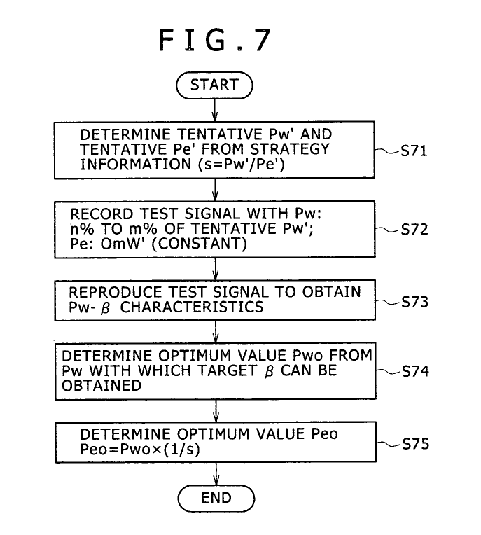

FIG. 7 is a flowchart of a method (3) of setting an optimum recording power when fixed at Peo=0 as in FIG. 3C.

In step S71, the strategy information is read out from the control data of the optical disk or the memory 13 of the apparatus, tentative Pw′ and tentative Pe′ are set from the described value, and their ratio is set to Pw′/Pe′=s. In step S72, Pw is varied within a predetermined range of n % to m % centered around tentative Pw′ and Pe is fixed at 0 to record a test signal. It should be noted that Pe=0 herein does not mean strictly zero, but means that the value is almost zero compared to the other value (Pw). In step S73, a test signal is reproduced and the β value is obtained. In step S74, the optimum value Pwo is determined from Pw with which the β value becomes Target_β. At this time, to compensate the shift in the β curve caused by assuming Pe=0, a corrected value is used for the value of Target_β. In step S75, the optimum value Peo is determined by multiplying Pwo by 1/s.

According to this method, there is only one β curve measured. Therefore, the optimum value determined from this is not affected by the type of the optical disk, variation in of the apparatus or temperature condition, so that stable results can be expected. In addition, the measurement is a one-step procedure of the β method, whereby shortened time can be achieved.

In this Example, as mentioned above, to determine the optimum recording power, the β method is employed in which the β value is obtained by fixing the erase power Pe and varying the recording power Pw. This enables determining the optimum power Pwo with high measurement sensitivity and high accuracy in a shorter measurement time. As a result, the demand for precise setting of the recording power such as BD can be satisfied. It should be noted that in the above description, some specific examples of how the erase power Pe to be fixed is given are mentioned, but it is not limited to these and can be suitably set considering the characteristics of the optical disk and apparatus.

While we have shown and described several embodiments in accordance with our invention, it should be understood that disclosed embodiments are susceptible to changes and modifications without departing from the scope of the invention. Therefore, we do not intend to bound by the details shown and described herein but intend to cover all such changes and modifications as fall within the ambit of the appended claims.

What is claimed is:

1. An optical disk apparatus for recording and reproducing data on an optical disk, comprising:
a signal forming circuit that produces a first test signal;
an optical pickup that irradiates the optical disk with a laser light based on the first test signal provided from the signal forming circuit to record the first test signal and reproduces the first test signal from the optical disk;
a detection circuit that obtains a β value representing asymmetry from the first test signal reproduced by the optical pickup; and
a control circuit that sets an optimum recording power Pwo from a recording power with which the β value obtained by the detection circuit becomes a target β value,
wherein the signal forming circuit produces a test signal whose erase power Pe is fixed and recording power Pw is varied as the first test signal.

2. The optical disk apparatus according to claim 1,
wherein the signal forming circuit produces a second test signal to determine the erase power Pe used for the first test signal and records it on the optical disk,
the detection circuit obtains a value of a modulation factor M representing an amplitude value from the second test signal reproduced from the optical disk, and
the signal forming circuit determines the erase power Pe used for the first test signal based on a result of the value of the modulation factor M obtained by the detection circuit.

3. The optical disk apparatus according to claim 1,
wherein the signal forming circuit determines the erase power Pe used for the first test signal according to recording conditions recorded in advance on the optical disk or recording conditions defined by the apparatus for the optical disk.

4. The optical disk apparatus according to claim 1,
wherein the signal forming circuit uses an approximately zero value (Pe≈0) as the erase power Pe used for the first test signal.

5. A method of setting a recording power when data is recorded on an optical disk, comprising:
recording on the optical disk a first test signal whose erase power Pe is fixed and recording power Pw is varied,
reproducing the recorded first signal to obtain a β value representing asymmetry of the reproduced signal for each recording power, and
setting an optimum recording power Pwo from a recording power with which the obtained β value becomes a target β value.

6. The method of setting a recording power according to claim 5,
wherein a second test signal is recorded on the optical disk to determine the erase power Pe used for the first test signal,
a value of a modulation factor M representing an amplitude value from the second test signal reproduced from the optical disk is obtained, and
the erase power Pe used for the first test signal is determined based on a result of the obtained value of the modulation factor M.

7. The method of setting a recording power according to claim 5,
wherein the erase power Pe used for the first test signal is determined according to recording conditions recorded in advance on the optical disk or recording conditions defined for the optical disk.

8. The method of setting a recording power according to claim 5,
wherein an approximately zero value (Pe≈0) is used as the erase power Pe used for the first test signal.
